(19) United States
(12) Patent Application Publication
(10) Pub. No.: US 2007/0041513 A1
(43) Pub. Date: Feb. 22, 2007

(54) Emergency call identification, location and routing method and system

(76) Inventor: Michael F. Gende, Lockport, IL (US)

Correspondence Address: GODFREY & KAHN S.C., 780 NORTH WATER STREET, MILWAUKEE, WI, 53202, US

(21) Appl. No.: 11/350,557

(22) Filed: Feb. 8, 2006

Related U.S. Application Data
(60) Provisional application No. 60/650,927, filed on Feb. 8, 2005.
(60) Provisional application No. 60/703,295, filed on Jul. 28, 2005.

(51) Int. Cl. H04M 11/04

(52) U.S. Cl. 379/37

(57) ABSTRACT

A method and system of receiving and handling emergency telephone calls from any source. The method and system provide a procedure and devices for transferring calls from a communications service provider to a packet switched network. On the network, the method and system associate a geographic location with the telephone number or device originating the call and determine an emergency call center to which the call should be routed. The call is routed to the call center via the packet switched network. The call is converted to a circuit switched format compatible with existing call center equipment and is presented to that equipment. A call center attendant answers the call and is presented with voice, a call back number, and caller location information. Other information may be proved as well. The method and system may provide verification of the geographic location of origin of the call.

### CROSS-REFERENCE TO RELATED APPLICATIONS

The present application claims priority to U.S. Provisional Patent Applications Ser. Nos. 60/650,927, filed on Feb. 8, 2005, and 60/703,295, filed Jul. 28, 2005, the disclosures of which are incorporated herein by reference.

### TECHNICAL FIELD

The present invention relates generally to routing of emergency telephone calls, and relates more specifically to a system and method of identifying and locating telephones and/or communications devices used to make emergency calls and routing the calls to an appropriate emergency call center.

### BACKGROUND

In traditional wired (also known as Circuit Switched) telephone systems, which has been the model for telephone systems installed throughout most of the world, the special routing of three digit, land-line calls for emergency services is well developed. An example is the U.S.'s traditional Public Switched Telephone Network (PSTN) Enhanced 9-1-1 (E9-1-1) system. That system uses a special 9-1-1 telephone “switch”, known as a Tandem Switch, which contains a database. That database contains records relating telephone numbers to the 9-1-1 call centers in a caller's area. This information is downloaded to the Tandem from an “up stream” data processing system at specific intervals.

In such a system, if a person dials the emergency access number from a telephone located within a particular jurisdiction, the call would be routed to a call center able to dispatch emergency services within that jurisdiction. “Enhanced” 9-1-1 systems—besides routing the call to a specific call center—also provide the caller's location to a call taker. This is provided from the same data processing system that uploads the Tandem with call routing information. The voice portion of these E9-1-1 calls is sent largely over copper wires which are the property of a telephone company. Such calls are said to be “circuit switched” as they require a wired circuit to operate. However, such a routing model does not interact well with many of the emerging wireless and Internet based communications topologies. These new topologies include routing of communications via “packet switched” networks, such as the Internet or other electronic data networks, and cellular or other wireless telephone networks. In fact, there are a growing number of consumers who are not using any traditional or conventional wired telephone services at all. These customers may be using a communications service with a packet switched approach delivered over the Internet, or may be relying entirely upon cellular phones, which also have access to the PSTN, to provide their basic and mobile service needs.

As these non-circuit switched communication services gain more customers, there are a growing number of persons for whom the traditional PSTN E9-1-1 system is not able to effectively route emergency calls to the proper emergency call centers. Improvements to the conventional systems and methods of handling emergency calls are desirable.

### SUMMARY

The present invention relates to a method and system of receiving and handling emergency circuit switched and packet switched calls. These calls may originate from a traditional telephone, Voice over Internet Protocol (VoIP) device, cellular device, or communications device as yet not available. The method and system provide a procedure and devices for transferring calls from a communications service provider to a packet switched network. On the network, the method and system use the geographic location of the telephone or device originating the call to determine an emergency call center to which the call should be routed. The call is routed to the call center via the packet switched network. The call may be converted to a circuit switched format that can be accommodated by existing telephony equipment in the call center. Upon answering the call, the call taker may be provided with voice, the caller's call-back number, and the location information associated of the caller. Other information about the caller may be also provided. The method and system may additionally provide verification of the geographic location of origin of the call.

### BRIEF DESCRIPTION OF THE DRAWINGS

The accompanying drawings, which are incorporated in and constitute a part of the description, illustrate several aspects of the invention and together with the description, serve to explain the principles of the invention. A brief description of the drawings is as follows:

FIG. 1 is a diagram illustrating the general architecture of an emergency call routing and handling system according to the present invention.

FIG. 2 is a diagram illustrating a process of location verification of a caller according to the present invention.

FIG. 3 is a diagram illustrating a process of receiving and processing an emergency call at an emergency call center according to the present invention.

### DETAILED DESCRIPTION

Reference will now be made in detail to exemplary aspects of the present invention which are illustrated in the accompanying drawings. Wherever possible, the same reference numbers will be used throughout the drawings to refer to the same or like parts.

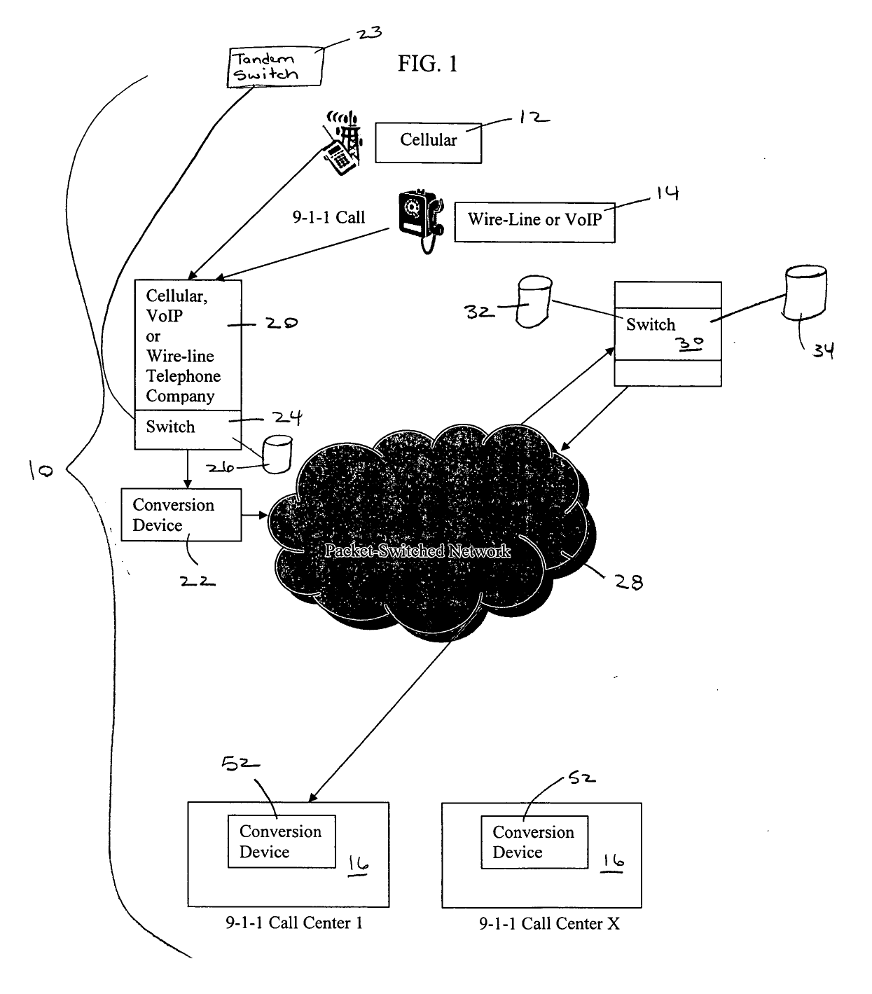

FIG. 1 illustrates a plurality of interconnected elements comprising an emergency call routing and handling system 10 which stretches between an initial call origination point (which may be for example, a cellular device 12, a wireline device or a Voice over Internet Protocol (VoIP) device 14, and one of a plurality of emergency call centers 16 (labeled respectively as “9-1-1 Call Center 1,” to “9-1-1 Call Center X”). System 10 also includes several intermediate devices, which will be described in further detail, below, that enable calls from any of the call origination points to be routed to the appropriate call center 16. This call center 16 will then be able to address the caller's issue, determine if some form of emergency response is appropriate and, if necessary, dispatch the appropriate and best located emergency response unit to assist the caller or transfer the caller to a call taker who can.

Conventional emergency call systems were designed and developed based on the assumption that a call coming to a call center would be coming from a traditional circuit switched lines. In such an arrangement, a billing record containing the telephone number and street address of a caller is provided by the communications provider to a 9-1-1 data processing service. These billing records are stored in a telephone number database. Also provided to the 9-1-1 data processing service is a Master Street Address Guide (MSAG). This MSAG may originates from the various municipalities or jurisdictions (such as counties) being served. The MSAG contains all street address ranges for a municipality. Each range is associated with a 9-1-1 Call Center. The billing record's address is searched in the MSAG database. If the address is found, the associated 9-1-1 call center is tied to that customer's telephone number. That telephone number to 9-1-1 call center relationship is then uploaded to the 9-1-1 tandem telephone switch. That tandem switch will be contacted by the telephone central office (CO) of the caller when this customer dials 9-1-1. The tandem switch will use that data to correctly route the caller to the correct call center. Data processing to accommodate new customers, MSAG changes, and tandem switch updates can be considerable and take time.

That method, using the PSTN Tandem as a router to 9-1-1 call centers, is not easily accessed by non-circuit switched communication technologies such as VoIP or Cellular, nor was it designed to be. The caller's location, traditionally gathered from a billing record and essential for the existing PSTN system to function, is no longer available from that source. Further, calls originating from a VoIP handset and directed to another VoIP handset may not pass through any portion of the PSTN facilities where the traditional circuit switched E9-1-1 system resides.

The present invention provides a system and a method of associating an address with a cellular or other wireless handset or device, as well as with VoIP devices, so that users of these devices can have 9-1-1 calls routed to proper call centers in a manner similar to conventional circuit switched PSTN device users. The present invention also provides a system and a method for permitting existing circuit switched emergency call centers to receive and process these packet switched calls without extensive equipment changeover. This permits existing 9-1-1 call centers to increase the scope of service they can provide without having to replace or reconfigure existing equipment, and without changing call answering practices and procedures.

In system 10, calls from any of the originating devices 12 or 14 are directed to a communications company 20 which is providing the service to that device. At company or service provider 20, if the call is originating from a non-VoIP device, the call is forwarded to a packet switched conversion device 22 where the call is converting into a packet protocol or format (for example, but not limited to, converted to a session initiation protocol or SIP) so that the call can be transferred over a packet-switched network 28, such as the Internet. If the call originates from a VoIP device, there is no need to route the call through conversion device 22, as the call is already in a packet format and is in suitable form for transfer over network 28.

Not all calls received by a telephone service provider may be directed to this packet switched transfer approach, so it is desirable for the service provider 20 to have a switch 24 receiving all 9-1-1 calls and querying the originating telephone numbers. The originating telephone number may be verified against a database 26 of telephone numbers of customers who have requested or subscribed to this service. If the call is determined to originate from a non-subscribing telephone number, the call is routing through the conventional wireline emergency call handling and routing system, indicated in FIG. 1 as being routed to a tandem switch 23. Such calls from non-subscribers may very well wind in one of the call centers 16 but are routed there by conventional devices and techniques outside of system 10. If the call is determined to have originated from a subscribing telephone number, the call can be routed to conversion device 22 for routing and handling according to the present disclosure.

The routing of the call across network 28 is preferably accomplished in a secure manner, to prevent unwanted disclosure of or tampering with the information being relayed to one of the emergency call centers 16. One example of such a secure transfer may be carried out via virtual private network (VPN) techniques, but this secure transfer is not limited to VPN. The call is transferred securely across network 28 to an automated switch 30 to determine the appropriate emergency call center 16 for routing the call. Switch 30 is preferably a “soft” switch or a computerized packet switch where the routing of the packet stream containing a call or calls is performed. The operation of switch 30 is independent of the nature of the device originating the emergency call, as all calls have been converting to a common packet format prior to being transferred to switch 30.

In switch 30, a pair of databases 32 and 34 are queried to determine how and to where the call should be routed. First, switch 30 queries database 32 using the originating telephone number. Database 32 includes information relating each telephone number to a physical location. Where conventional emergency call systems have relied on addresses associated with telephone numbers and matching against address ranges in MSAGs, database 32 of system 10 includes geographic coordinates for each subscribing telephone number. Such geographic coordinates are preferably expressed in latitude and longitude, but are not limited to these specific coordinates. Any appropriate and geographically distinct coordinates could be used within the bounds of the present disclosure.

Once these geographic coordinates associated with the originating telephone number have been identified, the coordinates may be queried against database 34 including a digital base map of the service boundaries of the different service areas of the different call centers 16. In such base maps, polygons are used to represent the service areas with defined boundaries for each polygon. Using common coordinate geometry or geographic information system analysis, the coordinates associated with the originating telephone number can be located within one of the service polygons. Having identified the appropriate call center 16 associated with the polygon—including geographic location information associated with the originating caller—the call can then be routed to that call center 16.

The call is maintained as a packet and forwarded to the selected call center 16 over network 28. Again, it is preferable that the packet be transferred in a secure manner, such via VPN techniques. As with conventional emergency call routing systems, there may be multiple call centers identified for each geographic location, with a list of priority of the order in which the call should be routed. This priority list may also be dynamically derived from the point-in-polygon analysis, using multiple layers of polygons defining primary and secondary service areas for each call center.

As system 10 receives emergency calls, relates these calls to a particular geographic location, and routes calls to an appropriate call center, system 10 may also provide verification of location to ensure the accuracy of the call center routing. For example, since VoIP devices may be located anywhere on the Internet and provide a reachable telephone number for a user, the billing address of the customer may not be the appropriate location to be associated with the customer in database 32. As such, when the user subscribes to VoIP service, the user may be provided with the option of entering a specific geographic location, such as an address, or even a geographic coordinate (if the user has the necessary equipment to gather such information, such a Global Positioning System (GPS) receiver). If the user is intending the service to be used solely at a fixed location, such as a home or business, the street address may be the correct geographic identifier and this address merely needs to be converted to latitude/longitude or some other coordinate pair for entry into database 32.

However, for cellular devices or for users who carry their VoIP devices to multiple of different locations, such a fixed address or location is not appropriate for database 32.

In the case of VoIP, the user may be provided the ability to update where the VoIP device is going to be located, such as when the customer moves the device between two or more regular or known locations. However, some degree of verification that the VoIP device is at the specified location may be desirable. For cellular devices, the location of the device may not be tied to any fixed address or geographic location, so that 9-1-1 network accommodation of the GPS capabilities of cellular phones to provide the location of the cellular device—and use that location to route the call to an appropriate call center—anytime an emergency call is made is desirable.

With VoIP devices, a first check may be made of the originated Internet Protocol (IP) address of the emergency caller. This IP address may indicate if the user is calling from a particular general region, and this region can be matched against the address in database 32. Alternatively, a user may not have entered a specific geographic location or address when the user subscribed to the VoIP service. In this case, a query of database 32 will return no specified address. In either case, when the call is routed to a call center 16, the operator handling the call can be provided with a message screen indicating that there is no address associated with the caller, or that the address or location given conflicts with the apparent origination of the call. The operator could then perform an initial query of the caller to determine where the caller is presently located and verify of the current call center 16 is appropriate location to handle the call.

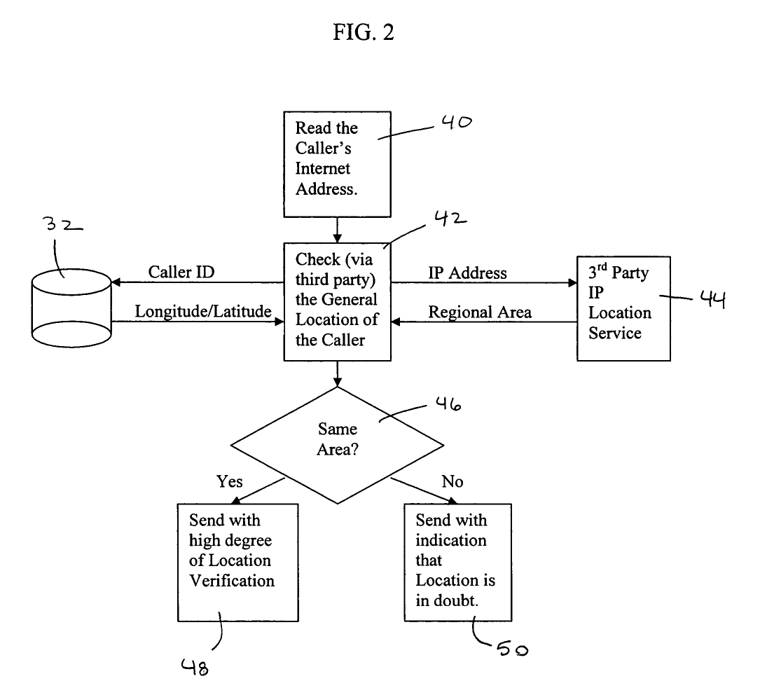

VoIP calls may be made from anywhere a person has an Internet connection, so that a US-based subscriber may be, for example, in Europe and make an emergency call. If that user has not updated the location to indicate that the device is in Europe, the IP address of the call would likely conflict with the address or location associated with the caller in database 32. In this case, the call may still be routed initially to a U.S. call center, where the operator might query the caller on their current location. Once the operator determined the user was located in Europe, the operator could attempt to route the call—via device 52, a communications device in its own right—to an appropriate call center in the user's current location. An example of an IP location verification process is shown in FIG. 2.

In FIG. 2, in box 40, the caller's IP address is read and forwarded to box 42. In box 42, the IP address is checked against a third party IP location service 44, while a parallel query involving the caller's telephone number (caller ID) is forwarded to database 32 to return the associated geographic location (longitude/latitude). IP location service 44 will preferably return an indication of the geographic origin of the emergency call. These two geographic locations are checked against each other in decision box 46 to see if the two are coincident or within some degree of allowable tolerance. If the two locations are acceptably close to each other, the call is forwarded to the appropriate call center 16 with a high degree of confidence in the location verification in box 48. If the two locations are not coincident or acceptably close, the call is forwarded to a call center 16 with an indication to the operator that the location of the caller is in doubt and should be verified, as shown in box 50. The call center 16 to which the call is forwarded may be the call center associated with the location held in database 32, the location indicated by the originating IP address, or some other designated call center.

With cellular calls, various techniques or device capabilities may provide a location of the caller or the device as the call is being made. Such techniques or devices may include triangulation based on the signal transmitted by the device and received by a plurality of cellular towers. Alternatively, many cellular devices are GPS enabled or include a GPS receiver built into the cellular device. Such GPS-equipped cellular devices may transmit a nearly exact geographic location coordinate along with the voice portion of the call. That transmitted geographic location can be used instead of any location information that may be stored in database 32. A process of verifying the location received from the cellular device may be carried out similarly to the process shown in FIG. 2, or the location of the cellular tower currently serving the cellular device may be used directly with database 34 to determine the appropriate call center 16.

At each call center 16, a conversion device 52 receives the incoming emergency call from network 28 being forwarded by switch 30. Conversion device 52 permits existing call centers 16 configured for conventional PSTN calls to be utilized with the system and method of the present disclosure. Within conversion device 52 a call directed to the specific call center from switch 30 is received in the form of a series of packets through network 28. Conversion device 52 converts the packet switched version of the call into a format compatible with the existing call answering equipment installed at the call center 16. The operator receiving the call and interacting with the caller to determine the nature of the issue and, if necessary, the location of the incident being reported is presented with the same screen or series of screens relaying information about the caller as would be presented by a PSTN circuit switched call. System 10 provides call centers 16 with the ability to receive and process calls from packet switched callers (VoIP customers, for example) or from mobile or cellular device users (Blackberry users, for example) without a change in the operators' equipment. All calls received by the call center would be presented to the operators in a consistent fashion.

When a call is answered by a 9-1-1 call center attendant, conversion device 52 forwards the caller's telephone number to a screen displayed to the operator, such as an Automated Number Identification (ANI) screen. Other conventional equipment within the call center 16 may then query for Automatic Location Information (ALI) associated with the caller's telephone number, such as a street address. Conversion device 52 will provide the location information derived from the upstream databases 32 and 34 which may be displayed to the operator in the same way that a conventionally derived address for a PSTN circuit switched call might be displayed.

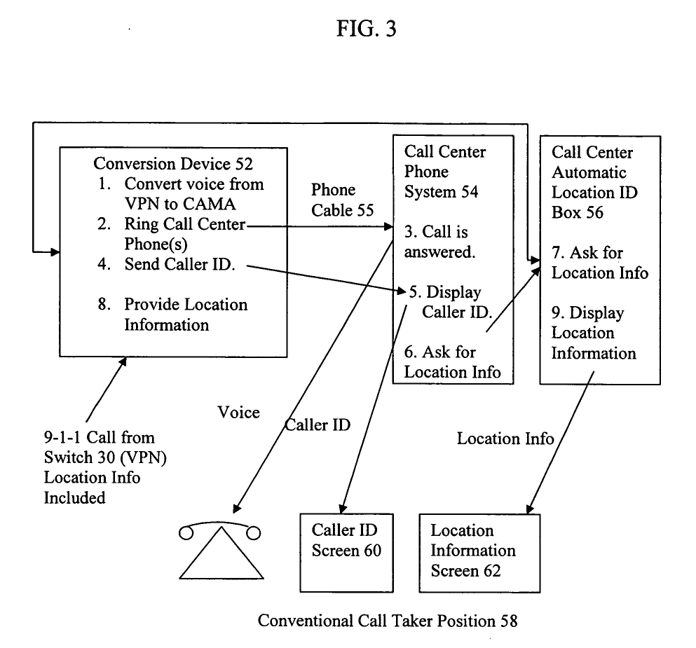

An example of a process for converting a packet switched call into a circuit switch compatible format to provide voice and other information to an operator at a conventional call center is illustrated in FIG. 3. In FIG. 3, a call is received by conversion device 52 and converted into a signal type recognized by conventional call center equipment, in this example Call Automated Message Accounting (CAMA) format. This call is then forwarded to a call center telephone system 54 by a conventional trunk line or telephone cable 55. System 54 answers the call and assigns the call to an operator at a call taking position 58. The voice portion of the call is transferred to position 58. Conversion device 52 then forwards the caller's telephone number to system 54 which in turn forwards the number to a caller ID screen 60 at position 58, where it is displayed to the operator. System 54 then performs its conventional query for location information associated with the telephone number, directing this query to ALI box 56. ALI box 56 in turn queries conversion device 52 for the location information included with the packet switched call. Device 52 provides the caller's location information back to box 56. ALI box 56 forwards the location information associated with the telephone number of the caller to location information screen 62 at position 58.

As noted above, location information screen 62 may display a note or warning to the operator that the location associated with the number is suspect and the operator should directly verify the location with the caller, if possible. Additionally, the type of call (VoIP, Cellular, or PSTN for instance) may be indicated.

Because system 10 relies on a series of devices or switches cascading within the message stream from caller to call center, and does not require that the call center equipment be altered in any way (outside of the inclusion of conversion device 52 to accept calls from the network into the call center), calls with system 10 may be routed to any emergency call center anywhere in the world. By contrast, conventional call centers may only transfer to other call centers or sites connected the same Tandem Switch that routes 9-1-1 calls to them. Conversion device 52 may be configured to accommodate any type of incoming line type that the call center's telephone equipment requires, regardless of the manufacturer or format of the call center equipment. System 10 permits flexible assignment of back up routing of call centers to handle overflow emergency calls or for when a primary call center may be off-line for some reason. Since system 10 uses a true packet network 28 for call transport, a variety of call forwarding and backup routes are possible. The call centers are now “nodes” on a true packet network. Such alternate packet routing happens automatically when required by network traffic conditions and is an integrated function of system 10.

System 10 also utilizes “packet cloud”, such as, but not limited to, the Internet to transfer messages. A secure connection, such as a VPN, is preferably utilized to transfer these messages and provide privacy. However, other emergency response groups may connect to the same “cloud” and be accumulated in “virtual command centers” provided by the devices shown in system 10. Alternatively, in widespread crisis or emergency response situations, a capability to communicate via unsecured connections may be provided, so that information can be shared with all desired emergency responders.

As cellular and other wireless devices come into wider spread use for communication around the world, system 10 permits these mobile communications devices to be incorporated into the emergency response system. System 10 may also permit existing call center equipment to have a greater installation lifespan by allowing it to adapt to and work with these known and growing communications trends, as well as adapting to new technologies as they are developed.

System 10 permits VoIP users to travel essentially anywhere in the world and still have access to emergency calling services. Anywhere a VoIP user can find an appropriate Internet connection, an emergency call can be made. The call can ultimately be routed to any call center in the world that has the ability to receive and communicate via packet switched messaging. If the call center has installed a conversion device 52, then the enhanced information related to caller ID and associated location can also be communicated to the call center anywhere in the world.

While the above description is related to inclusion of newer telephone communications protocols in the existing call center environment, system 10 can also be used to enhance the emergency call services provided to traditional PSTN customers. Since system 10 utilizes a geographic coordinate pair to locate callers or telephone installations on the earth, it could also be used to increase the accuracy and flexibility of the location of traditional PSTN customers. Instead of relying existing data processing of billing records and MSAGs, the identification of the correct 9-1-1 call routing could be accomplished by geographic coordinates and point-in-polygon analysis with respect to geographic databases of emergency response service areas. These geographic databases are easier to maintain than MSAGs, telephone number billing databases, and Tandem routing information uploads. These new methods dramatically reduce the data processing interval, allowing more rapid amendment of updates to coverage areas as jurisdictions grow and responsibility for services changes.

The embodiments of the invention disclosed herein have been discussed for the purpose of familiarizing the reader with novel aspects of the present invention. Although the preferred embodiments have been shown and described, many changes, modifications and substitutions may be made by one having skill in the art without necessarily departing from the spirit and scope of the present invention. Having described preferred aspects and embodiments of the present invention, modifications and equivalents of the disclosed concepts may readily occur to one skilled in the art. However, it is intended that such modifications and equivalents be included within the scope of the claims which are appended hereto.

What is claimed is:

1. A method of routing emergency calls, the method comprising:
receiving an emergency call;
determining the call back number of the device originating the call;
transferring the call in a packet switched format via a packet switched network to a routing switch;
at the routing switch, querying a database for a geographic location associated with the call back number of the originating device;
determining an emergency call center whose service area includes the geographic location associated with the call back number of the originating device; and,
transferring the call with geographic location and other information from the routing switch in the packet switched format via a packet switched network to the identified emergency call center.

2. The method of claim 1, further comprising converting the call from the packet switched format to a circuit switched format at the emergency call center.

3. The method of claim 1, wherein the call may originate from one of a PSTN, VoIP, or cellular communications device.

4. The method of claim 1, wherein the geographic location associated with the call back number is represented as a coordinate pair.

5. The method of claim 4, wherein the coordinate pair is represented in latitude and longitude.

6. The method of claim 1, wherein the service area of the emergency call center is represented as a polygon within a spatial database and the location associated with the call back number is determined dynamically by the routing switch upon receipt of the call to be within the polygon by point-in-polygon analysis.

7. The method of claim 1, further comprising a service provider receiving the emergency call and the service provider transferring the call to the packet switched network.

8. The method of claim 7, further comprising, after determining the call back number, the service provider analyzes each incoming emergency call to determine if the call originates from a subscribing call back number, if the call originates from a non-subscribing call back number, the call is forwarded to a tandem switch, and if the call originates from a subscribing call back number, the call is forwarded via the packet switched network to the routing switch.

9. The method of claim 7, wherein the emergency call received by the service provider is received in the packet switched format.

10. The method of claim 7, wherein the emergency call received by the service provider is received in a non-packet switched format and a conversion device at the service provider converts the call to the packet switched format.

11. The method of claim 1, wherein the call is transferred through the packet switched network to the routing switch and to the emergency call center in a secure method of transmission.

12. The method of claim 11, wherein the call is transferred through the packet switched via a virtual private network.

13. The method of claim 1, further comprising a plurality of emergency call centers having service areas including the location associated with the telephone number, with one of the emergency call center designated a primary emergency call center for that geographic location, and routing the call to the primary emergency call center.

14. The method of claim 13, further comprising determining the ability of the primary emergency call center to receive the call, and if the primary emergency call center is unable to receive the call, routing the call to one of the non-primary emergency call centers with service areas including the geographic location associated with the telephone number.

15. The method of claim 1, further comprising the routing switch verifying that the call is originating from a geographic location that corresponds to the geographic location associated with the telephone number in the database.

16. The method of claim 15, further comprising transferring the call to the emergency call center with an indication that the location of origin of the call does not correspond to the geographic location associated with the telephone number of the call.

17. The method of claim 15, wherein the call is made by an Internet telephone device and the regional or more granular location of the origin of the call is determined by analysis of an IP address associated with the call.

18. The method of claim 15, wherein the call is made by a cellular communications device and the location of origin of the call is determined by triangulation between a plurality of cellular towers receiving a signal from the cellular telephone device.

19. The method of claim 15, wherein the call is made by a cellular communications device which incorporates satellite location technology and the device includes a geographic location of origin with the call, and the location provided by the communications device will be used to route the call to the appropriate call center.

20. The method of claim 15, wherein the call is made by a cellular communications device which incorporates satellite location technology and the device includes a geographic location of origin with the call, and the routing switch uses the geographic location of origin of the call as the geographic location associated with the call to determine the emergency call center to receive the call.

21. The method of claim 1, wherein a plurality of call centers and emergency responders may receive the call with the location information from the packet switched network.

22. A system for routing emergency telephone calls, the system comprising:
a conversion device located at a circuit switched telephone service provider configured to receive and transfer emergency telephone calls from the service provider to a packet switched network;
a call routing switch configured to receive emergency telephone calls from the service provider conversion device via the packet switched network, the call routing switch configured to determine a geographic location of origin of the emergency telephone call and determining an emergency call center with a service area including the location of origin of the call, the call routing switch also configured to transfer the call to the emergency call center via the packet switched network; and
a conversion switch located at the emergency call center configured to receive the call from the call routing switch via the packet switched network and transfer the call to an operator at the call center with the location of origin.

23. The system of claim 22, wherein the call routing switch is configured to determine the location of origin of the call from querying a database of geographic locations associated with a telephone number of a device originating the call.

24. The system of claim 22, wherein the conversion device located at the service provider is configured to determine a call back number of a device originating the emergency call, verify the call back number against a database of subscribing call back numbers, and route calls from any non-subscribing call back numbers to a tandem switch.

25. The system of claim 22, wherein the call routing switch is configured to determine the location of origin of the call from information transferred to the call routing switch from a device originating the call.
